(19) United States
(12) Patent Application Publication
(10) Pub. No.: US 2017/0114943 A1
(43) Pub. Date: Apr. 27, 2017

(54) LEVELLING DEVICE WITH WEIGHING CELL AND USE THEREOF

(71) Applicant: NGI A/S, Nørresundby (DK)

(72) Inventor: Tomas Hecht OLSEN, Nørresundby (DK)

(21) Appl. No.: 15/317,721

(22) PCT Filed: Jun. 9, 2015
(86) PCT No.: PCT/DK2015/050151

§ 371 Date: Dec. 9, 2016

(30) Foreign Application Priority Data
Jun. 25, 2014 (DK) PA 2014 00333
Nov. 26, 2014 (DK) PA 2014 70738

(51) Int. Cl. F16M 7/00

(52) U.S. Cl. CPC F16M 7/00; F16M 2200/08

(57) ABSTRACT

The present invention is directed to a levelling device that includes a top part for fastening in a machine and a lower part for contact against a base. The lower part includes a housing and a sealing item, which is placed in the lower part. The lower part includes a weighing cell with an activation surface and an opposite placed surface. The weighing cell is placed in the housing and in the sealing item in the lower part. A power transmission device includes a lower end surface and an opposite placed upper surface. The lower end surface is placed in an area between a lower surface of a spindle facing towards the lower part and the activation surface. The end surface forms contact with the activation surface of the weighing cell or the lower surface of the weighing cell. Hereby, registration of the weight can be established.

### CROSS-REFERENCE TO RELATED APPLICATIONS

This application is a U.S. national stage of International Appl. No. PCT/DK2015/050151 filed 9 Jun. 2015, which claimed priority to Danish Appl. Nos. PA 2014 00333 filed 25 Jun. 2014 and PA 2014 70738 filed 26 Nov. 2014, which applications are all incorporated herein by reference in their entireties.

### TECHNICAL FIELD

The invention relates to a levelling device, which includes a top part for fastening in a device such as a machine, and a lower part for contact against a base such as a floor, and where the lower part includes a housing and a weighing cell with an activation surface and an opposite placed surface and that there is found a power transmission device with a lower end surface and an opposite placed upper surface.

### BACKGROUND

From U.S. Pat. No. 5,881,533 is known a machine foot including a weighing cell. The machine foot in the mentioned document is however unfit to be used in areas where high hygiene requirements exist for instance as a result of the complicated construction with many visible and exposed components, and it is not suited to be used in an earthquake area. The machine foot is however also specially designed to become mounted on packing machines for cigarettes.

### SUMMARY OF THE INVENTION

It is thus the object of the present invention to provide a levelling device, which does not have the stated drawbacks or which at least provides a useful alternative to the known technique.

This is achieved with a levelling device of the in the introduction stated and where there is also placed a sealing item in the lower part and that the weighing cell is placed in the lower part and is at least partially enclosed by the sealing item, and that the top part includes a spindle and that the lower end surface is placed in an area between the spindle's lower surface facing towards the lower part and the activation surface, which lower end surface is designed to form contact with the weighing cell's activation surface or the weighing cell's lower surface, by which the activation surface is designed for being able to become activated.

When a weight is applied on the levelling device mounted machine, the pressure will be transferred to the levelling device and the spindle will be pressed downwards. This pressure is transferred via the power transmission device to the weighing cell. The force will either affect the activation surface directly, which occurs when this surface faces towards the device or indirectly when it is the weighing cell's opposite surface, which has contact against the power transmission device. In this case, the weighing cell's activation surface will face towards the base and have contact against this and by force influence, the activation surface will thus press against the base and cause a result on a registration unit for the particular weighing cell.

The invention can also be used for a pressure equalisation of differently loaded levelling devices, since each individual levelling device in a complex has mounted a weighing cell as stated. The force from each levelling device is registered and compared in a registration unit, and if there are unacceptable differences, a pressure equalisation will occur such that each levelling device carries the same weight.

The weighing cell can be a weighing cell, which is connected to a registration unit via wire, or it can be a wireless unit.

By activation surface is understood the surface on a weighing cell, which by a force impact of the surface gives rise to an electrical signal, which can later be converted to a power value. The activation surface is placed in the lower part. The weighing cell is enclosed in a sealing item, preferably manufactured in a polymeric material such as a rubber mass. The power transmission device's lower end surface itself is also placed in or with contact against the lower part while the opposite placed surface is placed outside or in the lower part and either with contact against the spindle's lower surface or with a decided thread piece, which goes up in the spindle itself and is screwed into this by mesh with an inner thread in the spindle. An additional possibility is that the upper surface is placed in a recess in the power transmission device, which recess encloses an end part of the spindle.

Levelling device in this context includes an adjustable construction element, including an adjustable machine foot for supporting machines.

Levelling device can also include an adjustable leg, which supports a machine.

The adjustment of the device entails that the machine resting on the device can be set level or in a desired angle depending on the conditions.

In an additionally preferred embodiment, at least one of the surfaces, including the lower end surface of the power transmission device or the surface which the power transmission device forms contact against, are mostly plane or convex against the opposite surface.

It hereby contributes to getting a well defined pressure area for the pressure transfer, simultaneously with an inclining of the levelling device being made possible without it damaging the accuracy of the measured weight. Typically, the weighing cell's surface is with contact against the power transmission device's lower surface mostly plane or slightly convex in direction towards the power transmission device.

In an additionally preferred embodiment, there is in the area between the sealing item and the contact between the power transmission device and the weighing cell a first cavity, which cavity encloses at least the contact area, which is between the weighing cell and the power transmission device.

A free space is hereby achieved, which enables a movement between the weighing cell's surface and the pressure transmission device's contact to the weighing cell, without the grouting mass/the sealing item counteracting the movement and in this way could cause a false weight result. The cavity is preferably ring shaped, since the weighing cell is most often manufactured cylindrically. The cavity can, however, take other shapes such as quadratic et cetera.

In an additionally preferred embodiment, the lower end surface of the power transmission device is convex or concave in direction towards the contact surface against the weighing cell.

By this geometry, it is ensured that the surface can tip towards the weighing cell's surface such that when the levelling device stands slanted, there still occurs a correct pressure transmission to the weighing cell.

In an additionally preferred embodiment, the power transmission device's upper surface is in connection with a part of the spindle.

By connection is understood that the upper surface is either in direct touch contact with the spindle or that the upper surface is at least embedded in the spindle, which is the case when the power transmission device includes a rod shaped thread piece, which is screwed up in a threaded cavity in the spindle.

There is achieved a close connection between the two separate units, whereby the force is transferred directly.

In an additionally preferred embodiment, the power transmission device includes a bolt head, which bolt head includes a protruding part opposite placed the lower end surface, which protruding part is in connection with the spindle and that the bolt head is placed in the lower part.

A connection is hereby achieved between upper part and lower part and an unambiguous power transmission can occur to the weighing cell.

In an additionally preferred embodiment, the power transmission device is a bolt head with a protruding part, such as a tap, or the power transmission device is a bolt including a bolt head and a part protruding from the bolt head with an outer thread, which goes in mesh with an inner thread in the spindle.

In the case where the power transmission device only includes a bolt head with a smaller protruding part, this protruding part will have a surface, which is mostly congruent with the spindle's end surface, since this tap is not enclosed by the spindle, such which it is the case when the protruding part includes a thread. The tap takes part in ensuring a good contact between the lower part and the top part without the two parts being fixed connected to each other. At the same time, there is also achieved a good power transmission to the weighing cell. In the case where the protruding part includes a thread, is achieved a fixed connection between top part and lower part.

In an additionally preferred embodiment, the power transmission device includes a recess such as a thread hole, which recess'/thread hole's bottom surface includes the power transmission device's upper surface.

Good stability is hereby achieved by sideways displacement and a good connection between the power transmission device and the spindle.

In an additionally preferred embodiment, the recess includes a thread on the radial and vertical limiting sides, which thread is in mesh with an outer thread on the spindle's lower part.

The connection is hereby optimised between the two parts.

In an additionally preferred embodiment, there is between the recess' vertical sides and the spindle's lower part placed a tailstock screw.

Hereby, the connection between the two parts is fixed and an unintended loosening of the connection, for example during transport, is prevented.

In an additionally preferred embodiment, the levelling device includes a nut, which nut encloses an outer thread on the lower part of the spindle and that the nut's lower surface has contact against a part of the housing's outer limiting surface.

The two abutting surfaces are congruent and the nut's lower surface is concave in direction towards the base, while the housing has a convex part, which is enclosed by the convex part. This nut construction takes part in ensuring the stability of the construction in sideways direction, which is significant, partly during transport and also in areas where there are risk of earthquake.

In an additionally preferred embodiment, there is between the locking nut and the housing's surface placed a sealing item such as an O-ring and/or there is between the housing and the spindle placed a sealing item such as an O-ring, which last-mentioned O-ring encloses a part of the power transmission device's outer circumference placed outside the housing.

There is achieved a sealed connection between top part and lower part, which is important in areas with a high hygiene standard.

In an additionally preferred embodiment, there is between the sealing item and the housing's inner surface at least another cavity and in its periphery, the sealing item includes a ring going lip/sealing ring for sealing against the base.

The other cavity is placed in the area lateral of the weighing cell's periphery in the bottom of the lower part. By ensuring that there is not grouting mass in this area, it is achieved that the force registration is not hindered. If there had been a polymeric material with high resistance against pressure, such as the grouting mass, which additionally encloses the weighing cell, it would cause that the weighing cell did not become affected, corresponding to the pressure, which is on the levelling device and the weighing result would thereby become erroneous. Alternatively, the other cavity can be filled with a soft polymer, which does not exercise resistance against a pressure. The ring going lip/sealing ring ensures that there can not diffuse filth into the construction and that the amount of bacteria is reduced.

In an additionally preferred embodiment, the weighing cell's radially facing surfaces are shape complementary with internal surfaces of the sealing item, and that at least a part of the weighing cell's outer radially facing surfaces are in direct contact with the sealing item. It is hereby ensured that the weighing cell sits fixed in the lower part by friction between its walls and the sealing item.

In an additionally preferred embodiment, the sealing item includes several parts, including a bottom part, which bottom part fully or partially consists the lower part's lower surface for contact against the base and which bottom part covers the weighing cell's lower surface. Hereby, the weighing cell becomes hermetically wrapped in a closed part consisting of the housing and by the sealing item. The bottom part is a disc shaped circular part.

In an additionally preferred embodiment, the bottom part is fixed to the housing by fastening devices such as bolts.

In an additionally preferred embodiment, the levelling device is fixed to the base by bolts, which bolts drill through the housing and other parts of the lower part and is designed to be screwed fixed in the base.

Hereby, it is ensured that the machine mounted to the levelling device does not move from its position on the base.

In an additionally preferred embodiment, the weighing cell is designed with a protruding central part placed on the activation surface, which central part has contact against a central area of the lower surface on the power transmission device or the base.

By an additional aspect of the invention, the levelling device includes that all sealing rings in the levelling device consist of FDA approved NBR rubber material.

By an additional aspect of the invention, the levelling device includes that the sealing item is a polymeric material such as a rubber fastened to the housing by vulcanization.

It is hereby achieved that the attachment of the polymeric material to the housing is optimum and the attachment reduces the entry of filth and bacteria in the levelling device via the bottom of it.

By an additional aspect of the invention, the levelling device includes that all metal items have direct metallic contact under pressure.

It is hereby achieved that there is the same electrical potential in all metal items, which removes the risk of sparks.

By an additional aspect of the invention, the levelling device includes that there between the housing and the spindle is placed an anti-friction disc.

It is hereby achieved that the spindle can be moved in relation to the housing without risk of the metal, in contact between the two items, being ripped.

The invention also relates to the use of the above mentioned levelling device in locations with high requirements for hygiene such as locations for processing of foodstuffs or manufacturing of medicine.

Furthermore, the invention also relates to the use of the levelling device for support of a machine placed in areas with risk of earthquake.

### BRIEF DESCRIPTION OF THE DRAWINGS

The invention will now be explained more fully with reference to the drawing, where

FIG. 1A shows a sectional view of a first embodiment of a levelling device, according to the invention, including a top part and a lower part.

FIG. 1B shows a sectional view of the in FIG. 1A shown levelling device, resting on an inclined base.

FIG. 2A shows a sectional view of another embodiment of a levelling device, according to the invention, including a top part and a lower part.

FIG. 3A shows a sectional view of a third embodiment of a levelling device, according to the invention, including a top part and a lower part.

FIG. 3B shows a sectional view of the in FIG. 1A shown levelling device resting on an inclined base.

FIG. 4 shows three identical weighing cells in different perspective for use in a levelling device according to the invention.

FIG. 5A shows a first embodiment of a power transmission device for use in a levelling device according to the invention.

FIG. 5B shows the in FIG. 5A shown power transmission device seen in its full length.

FIG. 6 shows another embodiment of a power transmission device for use in a levelling device according to the invention.

FIG. 7 shows a levelling device, seen from the bottom, and before a weighing cell is placed in the foot.

FIG. 8 shows the in FIG. 7 shown levelling device, seen from the bottom, and where the weighing cell is placed.

FIG. 9 shows a completely assembled levelling device, according to the invention, seen in perspective.

FIG. 10 shows a fourth embodiment of a levelling device according to the invention

FIG. 11 shows the in FIG. 10 shown embodiment example of a levelling device seen in sectional view.

FIG. 12 shows a fifth embodiment example of a levelling device according to the invention.

FIG. 13 shows the in FIG. 12 shown embodiment example of a levelling device seen in sectional view.

FIG. 14 shows a magnified section of a sealing area and marked with F in FIG. 11 and FIG. 13

FIG. 15 shows a magnified section of a sealing area and marked with D in FIG. 11 and FIG. 13

FIG. 16 shows a magnified section of an area marked with G between lower part of the spindle and power transmission device including a tailstock screw for locking of spindle to the power transmission device

### DETAILED DESCRIPTION OF THE INVENTION

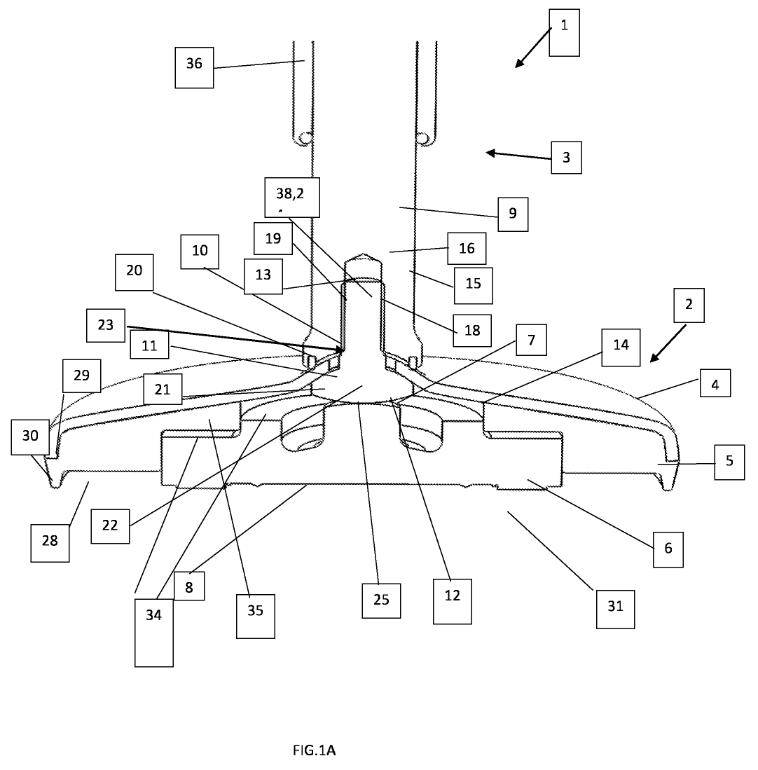

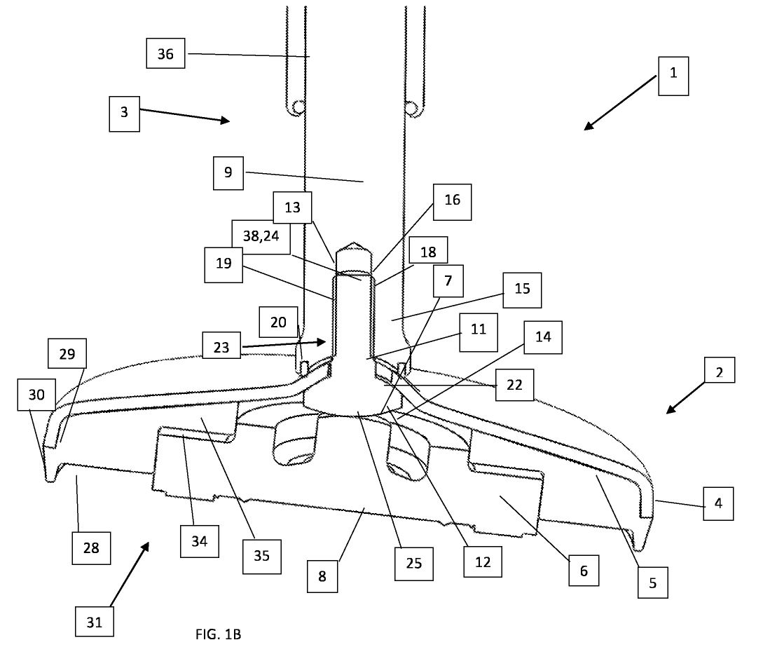

With reference to the FIG. FIGS. 1A, 1B, 2, 3A and 3B the levelling device 1 will, according to the invention and in the subsequent discussion be mentioned as a machine foot 1, become gone through, since the principle difference between the three embodiment examples is the design of a power transmission device 11 and of this derived construction changes for the machine foot 1.

The figures show the machine foot 1 including a top part 3 for fastening in a device, such as a machine, and a lower part 2 for contact against a base 31, such as a floor, and where the lower part 2 includes a housing 4, and a preferably ring shaped sealing item 5, which is enclosed in the housing 4. The sealing item 5 partially encloses a weighing cell 6. The top part 3 includes a spindle 9. Between top part 3 and lower part 2, the power transmission device 11 is enclosed. This is in FIG. 1 shaped as a bolt 23 including a bolt head 22, which is the actual part of the power transfer against the weighing cell 6, since the bolt head's lower surface's 12 top point 25 and central part are what have contact against a surface on the weighing cell 6. This surface is in this case the weighing cell's upper surface: an activation surface 7, which means the surface, which is pressed down by a force impact of the weighing cell 6. The surface which the bolt head's 12 lower surface 12 has contact against could also be the weighing cell's 6 opposite placed surface and here lower surface 8 meaning that the weighing cell 6 should be turned 180 degrees. The pressure registration will then occur by the activation surface 7 pressing against the base 31 by a force impact of the machine foot 1 and hereby give rise to a measuring of a weight, which loads the, on the foot mounted, machine.

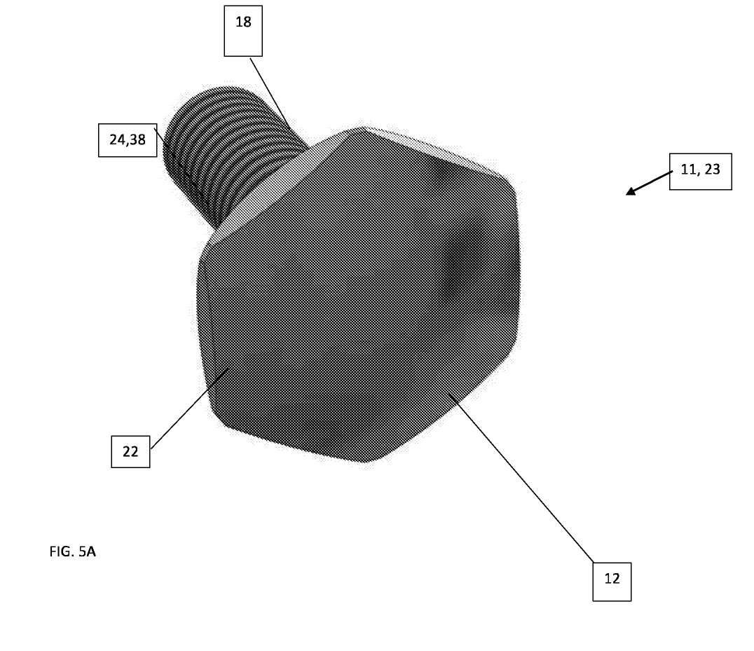

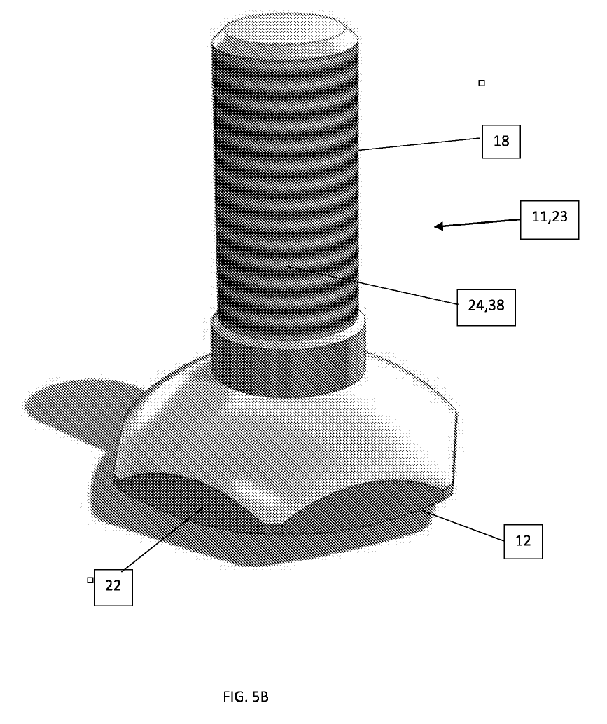

In FIGS. 1A and 1B the power transmission device 11 is as mentioned designed as a bolt 23 including the bolt head 12 and a protruding tap 38 consisting of a thread part 24 with an outer thread 18, which is screwed up in the lower part of the spindle 15 including a cavity 16 with an inner thread 19 such that the power transmission device's 11 upper surface 13 is placed in the spindle's 9 inner thread 19. FIGS. 5A and 5B shows the power transmission device 11 used in the in FIGS. 1A and 1B shown machine foot 1 and reference numbers present the same technical details as stated above.

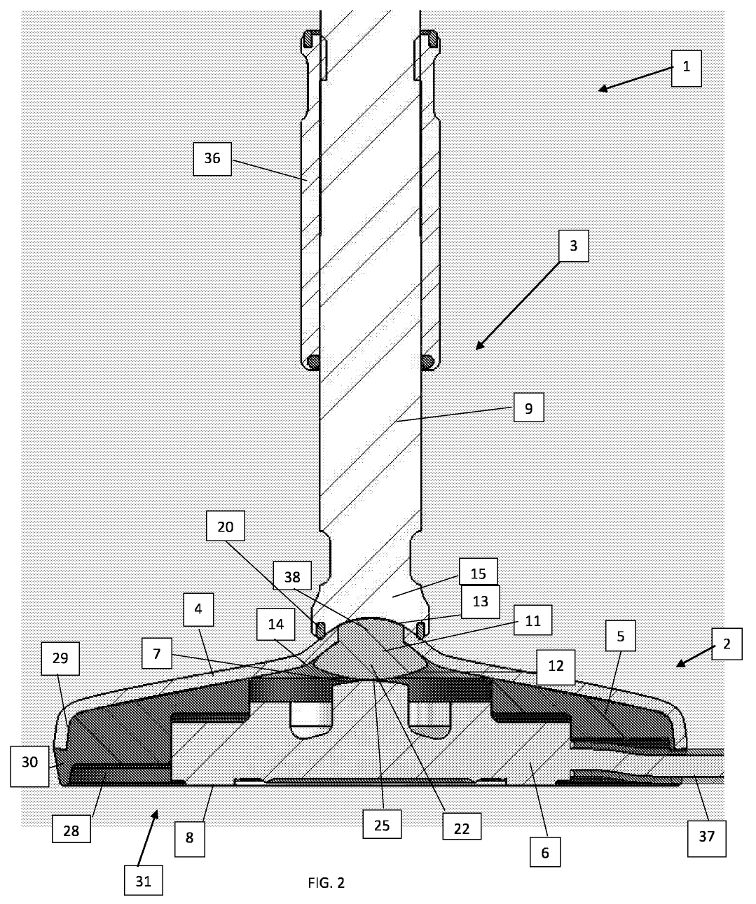

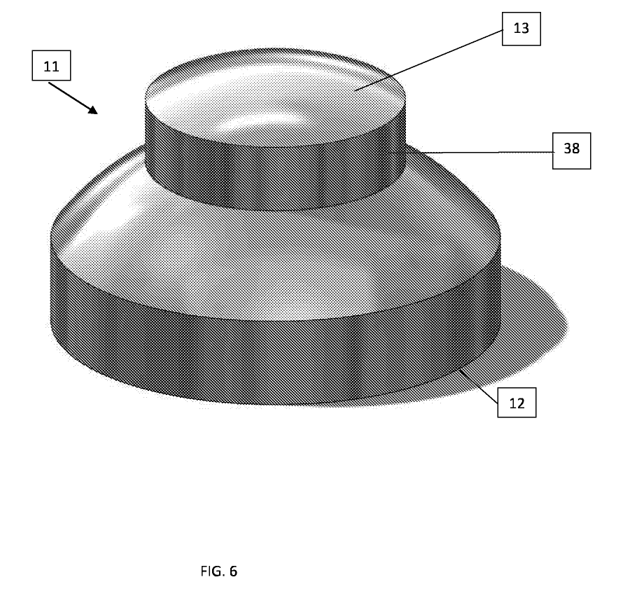

In FIG. 2, the power transmission device 11 is designed solely as a bolt head 22 with a protruding tap 38 and has an upper surface 13, which is placed substantially complementarily shaped against the spindle's lower surface in the lower part 15. FIG. 6 shows the power transmission device 11 used in the machine foot 1 shown in FIG. 2, where the bolt head's 22 contact surface 12 against the activation surface 7 is convexly shaped and the contact against the weighing cell's 6 activation surface 7 is therefore mostly point formed, and as it is seen in FIG. 2, the two surfaces will easily be able to be moved in relation to each other by a tipping movement of the machine foot 1. This is relevant when the base 31 is inclined and/or it is exposed to vibrations. The power transmission device 11 is typically manufactured in a stainless steel material.

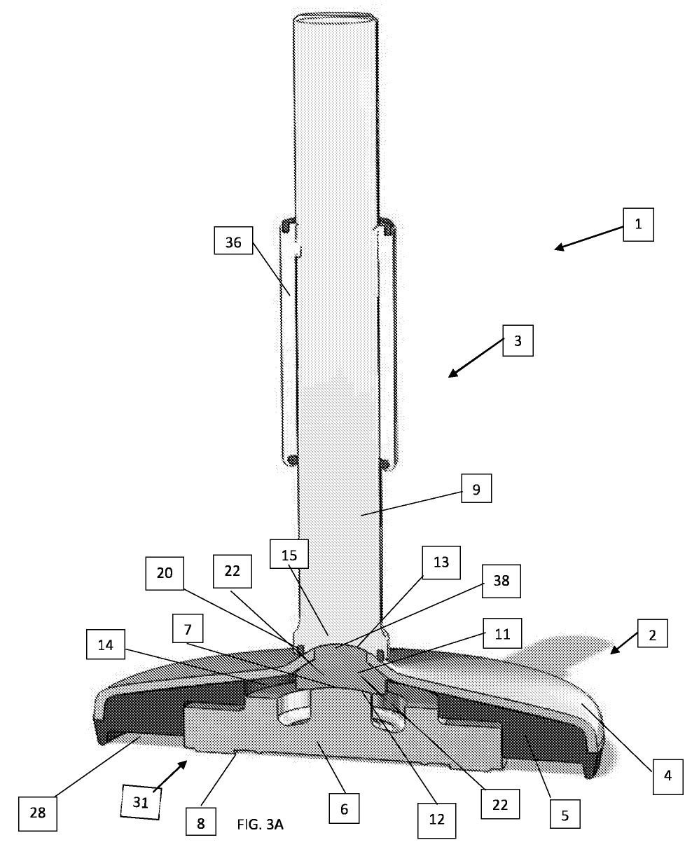

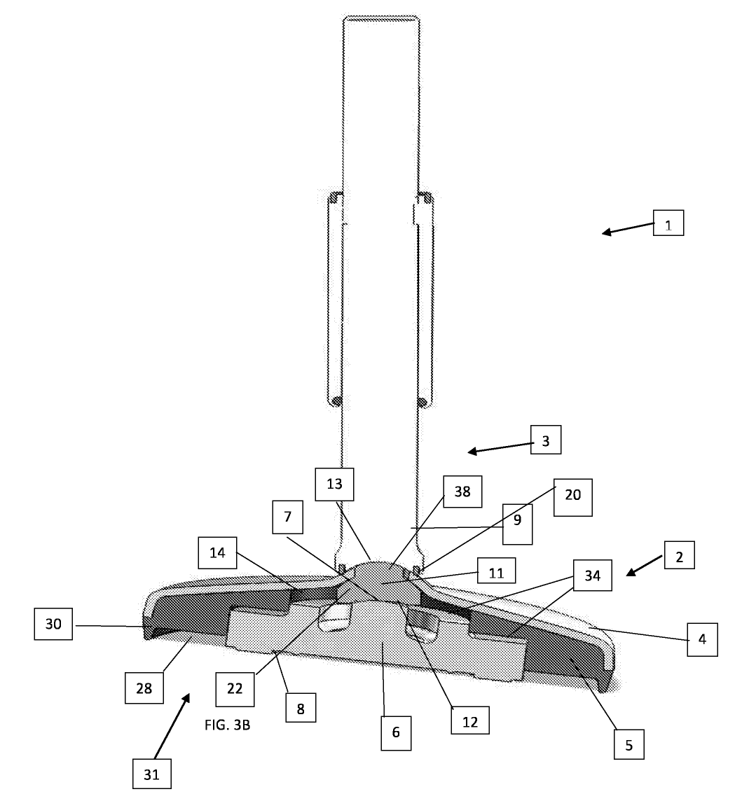

In FIG. 3, the power transmission device is designed with a bolt head 22 and a tap 38, where the bolt head 22 is concave shaped against the weighing cell's 6 activation surface 7, which is slightly convex. The two surfaces are mostly shape complementary. Also here, the two surfaces will be able to take different positions, moved, in relation to each other, which is demonstrated by FIG. 3B, where the machine foot 1 is inclined due to a slanted base 31. This results in that the two contacting surfaces are tipped in relation to each other, and the encircling first cavity 14 ensures that the movement is not prevented by the sealing item 5.

The power transmission device 11 is thus placed between the spindle's 9 lower surface facing against the lower part 2 and the activation surface 7. The power transmission device 11 includes the protruding part/tap 38 opposite the lower end surface 12, which protruding part 38 is in connection with the spindle 9, while the bolt head 22 itself is placed in the lower part 2. In all the embodiment examples, the bolt head 22 is placed in the lower part 2.

The weighing cell 6, which is used, can for example be from the brand “Sartorius”. The weighing cell 6 is as mentioned partially enclosed by the sealing item 5, which is a suited rubber mass, such that parts of the weighing cell's 6 periphery are shape complementary enclosed by the sealing item 5. Between sealing item 5 and weighing cell 6, there are at least two cavities, namely a first cavity 14 and another cavity 28, both preferably ring shaped. The cavities can take on other geometries depending on the weighing cell's outer surfaces. The cavity can thus be a quadratic or rectangular cavity. These cavities 14, 28 exist such that the weighing cell's 6 movements are not obstructed by the rubber mass such that a correct registration of weight can occur simultaneously with that the rubber mass ensures a sealed barrier out towards the surrounding space. The first cavity 14 is placed in the area between the sealing mass 5 and the contact surface between the bolt head 22 and the weighing cell's 6 activation surface 7, while the other cavity 28 is at least placed in basis of the housing 4 such that at least a part of basis of the weighing cell 6 forms the contact with the base 31 without the rubber material preventing the force registration. The sealing item 5 however includes, in its periphery 29, a ring shaped sealing lip 30, which seals the housing 4 against the base 31. The lip 30 is however so flexible that it does not counteract the weighing cell's 6 movement and has thereby no influence on the weighing result.

In the shown constructions in FIGS. 1A, 1B, 2, 3A and 3B there is a need for additional cavities 35, namely above a horizontally placed surface 34 vertically displaced in relation to the activation surface 7.

The weighing cell 6 is, as shown in the examples, connected via a wire 37 to a registration unit, but could also function wirelessly. In the cases where the weighing cell 6 is connected to the registration unit via wire 37, this wire 37 will be wrapped up in an airtight hose. Hereby, it is protected against damage.

An O-ring 20 is placed between the spindle's 9 lower surface 15 and the housing 4 and enclosing the bolt head 22.

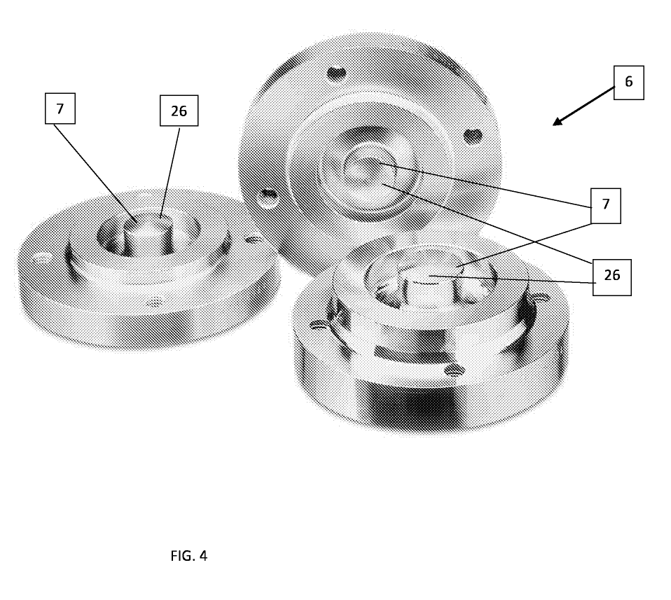

FIG. 4 shows three identical weighing cells 6 in different perspective for use in a machine foot 1 according to the invention. The weighing cell 6 is a cylindrical unit with a protruding part 26, where the activation surface 7 is placed. The weighing cell 6 can weigh up to 5 tons and registers weight changes down to 5 grams. The weighing cell 6 is therefore suited for being incorporated in machine feet 1 according to the invention. The machine foot 1 can thus with high success be used in process units where weighing of a product is significant either during the process itself or as registration of the final product's weight.

The weighing cell 6 is also suited for being used in machine feet 1 where the machine foot 1 is used for levelling a machine mounted on the machine feet 1, since a weight difference between the carrying feet on the machine will become registered and a subsequent correction of the mutual position of the machine feet 1 can be established, until the weighing cells 6 on the measured machine feet show the same weight distribution.

FIG. 7 shows a machine foot 1 seen from the bottom and before a weighing cell 6 is placed in the foot 2 and shows a cavity in the sealing item 5, which is placed in the housing 4. The cavity is shaped such that there is room for the weighing cell 6, such that it can be placed in the cavity and fits by a press fitting, whereby the friction fixes the weighing cell 6 in the housing 4. The previously mentioned first 14 and other 28 cavities are provided in the sealing item 5. But since these cavities are laid by and/or parallel to the weighing cell's 6 horizontal surfaces, it does not influence the friction between weighing cell 6 and sealing item 5, since the grouting mass' vertical walls are shape complementary with the weighing cell's 6 vertical walls. The open bottom can be covered with a bottom part as described below.

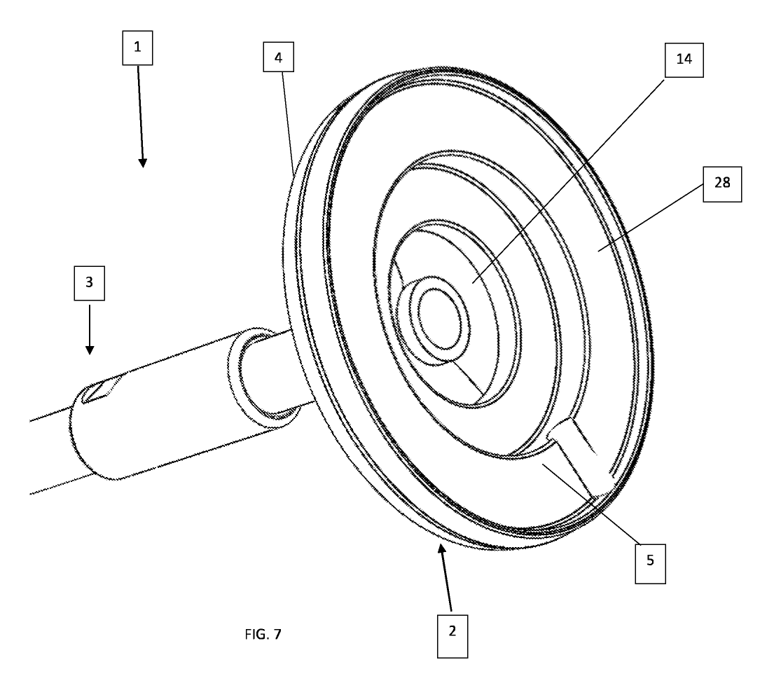

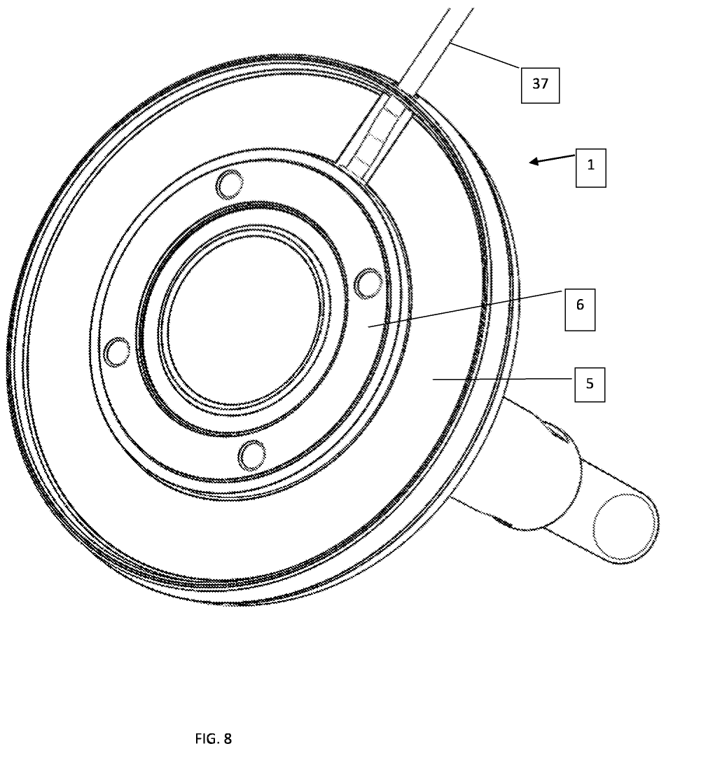

FIG. 8 shows a machine foot 1, seen in perspective from the bottom, and where the weighing cell 6 is placed in the sealing item 5 and a wire 37 emanates from the weighing cell 6.

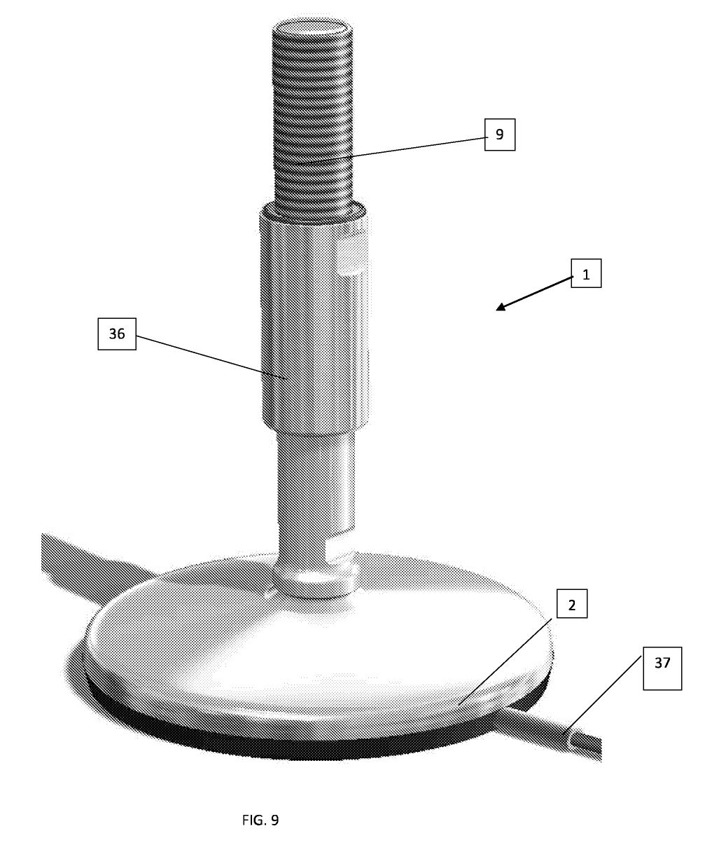

FIG. 9 shows a completely assembled machine foot 1, according to the invention, seen in perspective and including a spindle 9 provided with a thread shielding 36 and the lower part 2 with a weighing cell 6 incorporated.

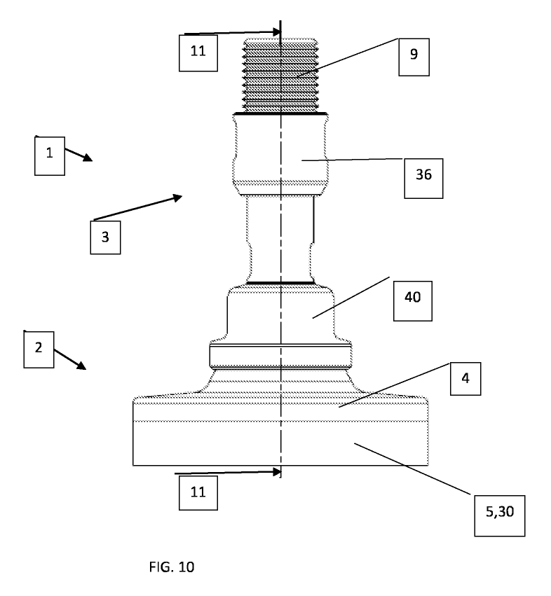

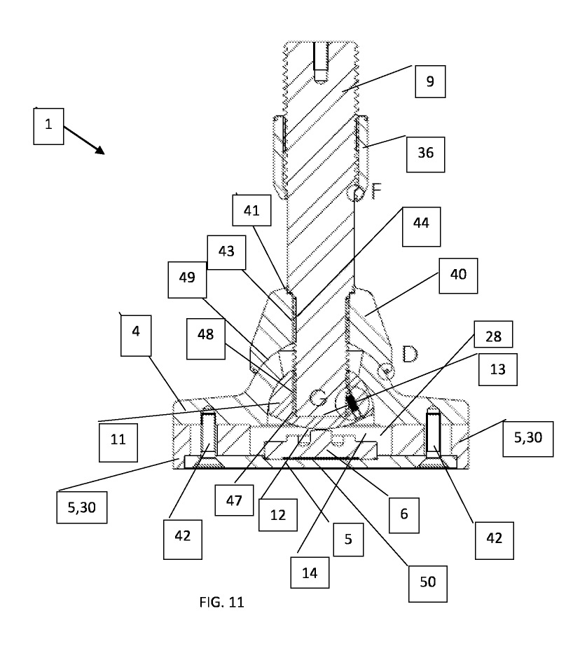

FIG. 10 shows a fourth embodiment example of a levelling device 1 according to the invention, and FIG. 11 shows the exemplary embodiment of the levelling device of FIG. 10 in sectional view. The shown embodiment example includes a nut 40, which encloses a lower and outer thread 43 on the spindle 9 and which is screwed towards the housing's 4 upper outer surface. The housing's 4 outer and upper surface is convex upwards and the nut's 40 surface facing towards the housing 4 is concave downwards such that the surfaces, which are pressed against each other, at the nut's 40 screwing in, are congruent. The nut's 40 lower surface 49 has thus contact against a part of the housing's 4 outer limiting surface. In the periphery, marked D, is laid a sealing ring 41, see FIG. 15, which ensures sealing against the surroundings. This is seen clearly in FIG. 15. The power transmission device 11 itself includes a thread hole 47 with a thread 48, in which the spindle's 9 lower part is screwed down since the spindle 9 includes the outer thread 43 on this lower part. The spindle 9 is screwed in until it bumps against the upper surface 13.

In order to lock the two components against each other, there is screwed in a tailstock screw 46 in the area marked G and as shown in FIG. 16. The tailstock screw is screwed in such that it with a part bumps against the outer thread 43 on the spindle 9 and against the inner thread 48 on the power transmission device 11.

The weighing cell 6 itself is enclosed in a sealing item 5, which includes several separate units. A sealing item, including a bottom part 50, is placed in the bottom of the device 1 and is screwed in by bolts 42, which proceed from the bottom surface of the sealing item 50 up towards a sealing item 5 inside the housing 4 and up to the housing's 4 inner surface, to the lower part 2. This sealing plate 50 will together with the nut 40 ensure that the weighing cell is hermetically closed inside the levelling device 1 and thus that bacteria do not have a chance of contaminating the inside of the device. Furthermore, the nut 40 helps to stabilize against sideways forces. The bottom part 50 is a circle shaped disc manufactured in the same material as the rest of the sealing item 5.

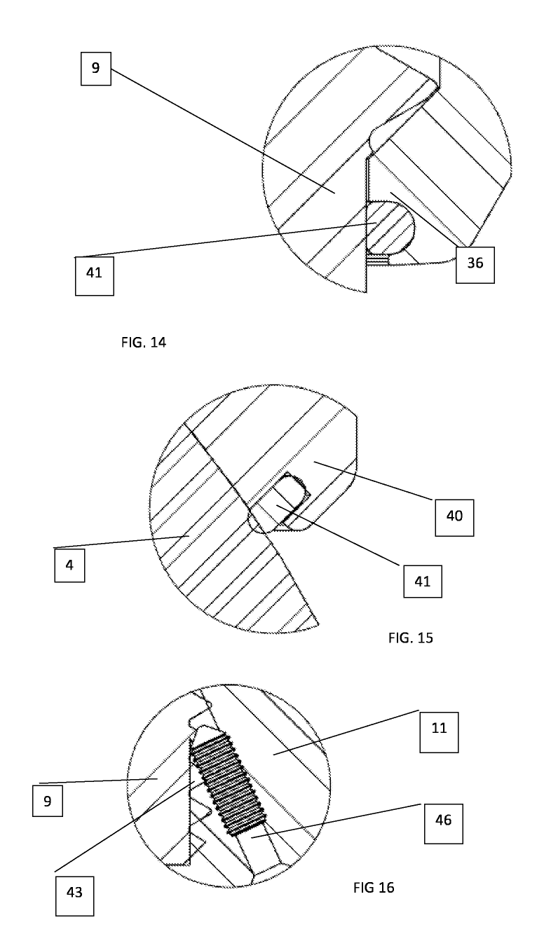

It is additionally noted that there with F is marked an area, which is shown magnified in FIG. 14, and which shows a sealing item 41 between the spindle 9 and the thread shielding 36 in the area, which faces towards the lower part 2.

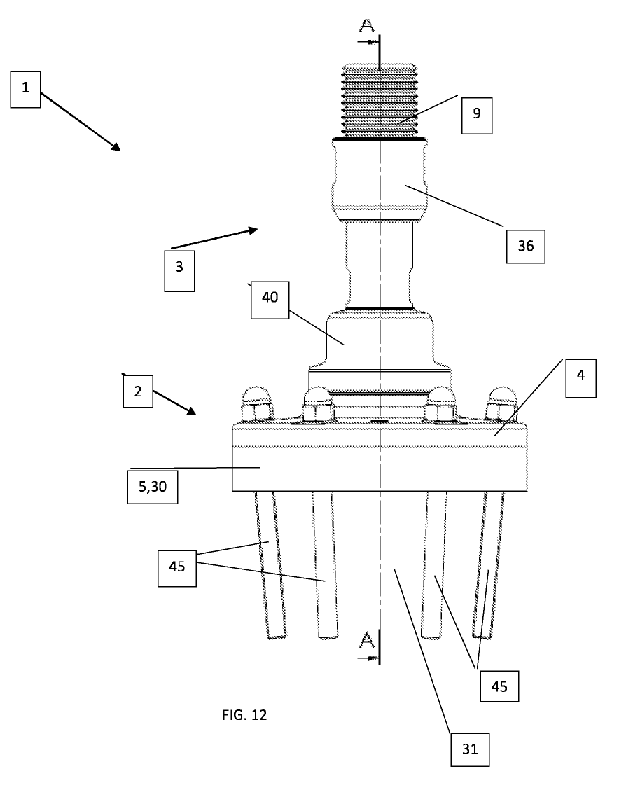

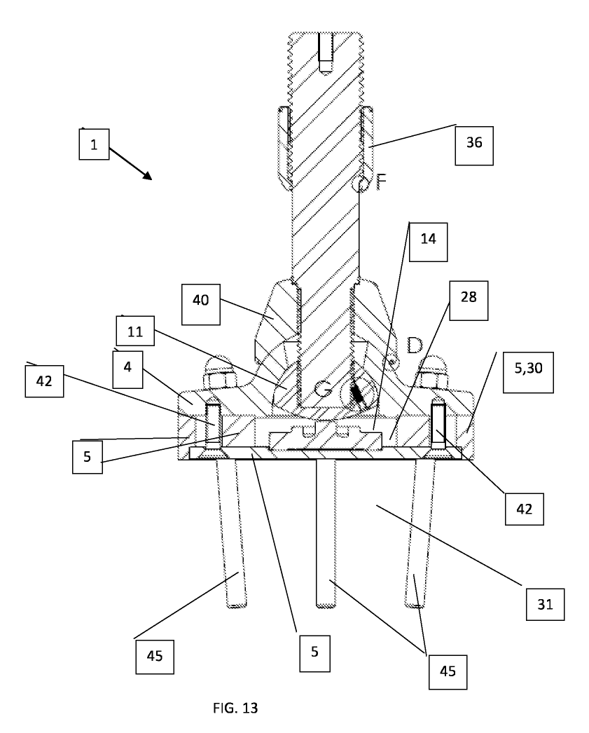

FIG. 12 shows a fifth embodiment example of a levelling device 1 according to the invention, and FIG. 13 shows the exemplary embodiment of the levelling device shown in FIG. 12 in sectional view. The difference between this embodiment example and the embodiment shown in FIGS. 10 and 11 s that the embodiment of FIGS. 12 and 13 includes bolts 45, which lock in place the levelling device 1 to the base. The bolts 45 perforate the housing 4 and other parts of the lower part 2 and are screwed into the base 31 in holes designed for that purpose.

The fourth and fifth embodiment example on a levelling device 1 also includes the previously mentioned cavities: first cavity 14 and other cavity 28.

All sealing rings in the machine foot appropriately consist of FDA approved NBR rubber material.

All metal items in the machine foot are appropriately in electrical contact since they are either screwed together or have direct metallic contact under pressure and thereby have the same potential whereby it is prevented that there can occur potential differences and subsequent possibility of sparks.

### REFERENCE NUMBERS

1 Levelling device

2 lower part

3 top part

4 housing

5 sealing item

6 weighing cell

7 activation surface

8 opposite placed surface

9 spindle

10

11 power transmission device

12 11's lower end surface

13 11's upper surface

14 a first cavity.

15 part of the spindle (including the lower surface and/or a cavity in the spindle)

16 cavity spindle

17

18 outer thread

19 inner thread placed in the spindle's lower part

20 sealing object such as an O-ring

21

22 bolt head

23 bolt

24 thread piece,

25 the bolt head's top point

26 protruding part placed on the weighing cell Central area of the lower surface on the power transmission device

28 another cavity

29 the sealing item's periphery

30 ring going lip

31 the base

32 the weighing cell's external surfaces

33 internal surfaces of the sealing item

34 horizontal surface

35 additional cavity

36 thread shielding

37 wire

38 tap

40 locking nut

41 sealing ring

42 bolts for sealing item

43 spindle's lower and outer thread

44 locking nut inner thread

45 bolts for sealing item for base

46 tailstock screw

47 thread hole

48 47's inner thread

49 locking nut's lower surface

50 The sealing item's bottom surface

1.-17. (canceled)

18. A levelling device, comprising:
a top part for fastening in a device,
a lower part for contact against a surface and comprising a housing and a weighing cell, wherein the weighing cell comprises an activation surface and an opposite placed surface, and
a power transmission device with a lower end surface and an opposite placed upper surface,
wherein the lower part comprises a sealing item at least partially enclosing the weighing cell,
wherein the top part comprises a spindle and the lower end surface of the power transmission device is placed in an area between the a lower surface of the spindle and the activation surface, and
wherein the lower end surface is configured to form contact with the activation surface or lower surface, by which the activation surface is designed for being activated by a force impact of the weighing cell.

19. The levelling device according to claim 18, wherein at least one of the lower end surface of the power transmission device, the lower surface or the activation surface which the power transmission device forms contact against, is substantially plane-shaped or convex against the opposite surface.

20. The levelling device according to claim 18, further comprising a first cavity formed between the sealing item, the power transmission device and the weighing cell, wherein the cavity encloses at least the contact area between the weighing cell and the power transmission device.

21. The levelling device according to claim 18, wherein the lower end surface of the power transmission device is convex or concave in direction towards the contact surface against the weighing cell.

22. The levelling device according to claim 18, wherein the upper surface of the power transmission device is in connection with a part of the spindle.

23. The levelling device according to claim 18, wherein the power transmission device comprises a thread hole, wherein the bottom surface of the thread hole includes the upper surface of the power transmission device.

24. The levelling device according to claim 23, wherein the threaded hole includes a thread on the radial and vertical limiting walls, which thread is in mesh with an outer thread on the lower part of the spindle.

25. The levelling device according to claim 24, wherein a tailstock screw is positioned between the vertical limiting walls of the threaded hole and the lower part of the spindle.

26. The levelling device according to claim 18, wherein the levelling device further comprises a nut enclosing an outer thread on the lower part of the spindle and that a lower surface of the nut is configured for contact against a part of the outer limiting surface of the housing.

27. The levelling device according to claim 26, wherein a first sealing item is positioned between the nut and the surface of the housing.

28. The levelling device according to claim 18, wherein at least another cavity is positioned between the sealing item and the inner surface of the housing, and wherein the sealing item comprises a peripheral ring going lip for sealing against the surface.

29. The levelling device according to claim 18, wherein the radially facing surfaces of the weighing cell are complementarily shaped with the internal surfaces of the sealing item, and wherein at least a part of the outer radially facing surfaces of the weighing cell are in direct contact with the sealing item.

30. The levelling device according to claim 18, wherein the sealing item comprises a bottom part comprised of the lower surface of the lower part for contact against the surface and that the bottom part covers the lower surface of the weighing cell.

31. The levelling device according to claim 30, wherein the bottom part is fixed to the housing by one or more fastening devices.

32. The levelling device according to claim 18, wherein the levelling device is fixed to the surface by bolts, which bolts penetrate the housing and are designed for becoming screwedly fixed into the surface.

33. Use of the levelling device according to claim 18 in locations with high requirements for hygiene such as locations for processing of foodstuffs of manufacturing of medicine.

34. Use of the levelling device according to claim 18 for support of a machine placed in areas with risk of earthquake.

35. The levelling device according to claim 26, wherein a sealing item is positioned between the housing and the spindle, the sealing item is configured to enclose a part of the outer circumference of the power transmission device placed outside the housing.
